(19) United States
(12) Patent Application Publication
(10) Pub. No.: US 2024/0124713 A1
(43) Pub. Date: Apr. 18, 2024

(54) LIGNIN-BASED BIODEGRADABLE POLYMERS AND METHODS OF MAKING THE SAME

(71) Applicant: The Florida State University Research Foundation, Inc., Tallahassee, FL (US)

(72) Inventor: Hoyong Chung, Tallahassee, FL (US)

(21) Appl. No.: 18/472,636

(22) Filed: Sep. 22, 2023

Related U.S. Application Data
(60) Provisional application No. 63/408,891, filed on Sep. 22, 2022.

(51) Int. Cl. C08L 97/00; C08K 5/3445; C08L 67/00; C08L 69/00; C08L 75/04

(52) U.S. Cl. CPC C08L 97/005; C08K 5/3445; C08L 67/00; C08L 69/00; C08L 75/04; C08L 2201/06

(57) ABSTRACT

Disclosed are methods of forming lignin-based biodegradable polymers. The methods comprise the use of a coupling reagent allowing formation between lignin-based material and an additional polymer material. The formed polymers include lignin-based polycarbonates, lignin-based polyurethanes, and lignin-based polyesters.

### CROSS-REFERENCE TO RELATED APPLICATION

This application claims the benefit of U.S. Provisional Application 63/408,891, filed Sep. 22, 2022, the contents of which are hereby incorporated in its entirety.

### FIELD

The present invention relates generally to lignin based biodegradable polymers that can, for example, be used to replace current petroleum-based plastics and methods for making the same. The present invention also relates to articles comprising the described lignin based biodegradable polymers and methods for the manufacture and use of the same.

### BACKGROUND

Plastics have become an inseparable part of modern life. Due to their versatility and continuous use over 300 million tons of plastic material are produced yearly, with about 50% of it for a single purpose. However, the durability of plastics creates disposal problems, and large amounts of plastics are disposed in landfills or dumped into the oceans each year. Conventional plastics take a long time to decompose, which is often accompanied by toxic chemicals being into soil and water. Meanwhile, plastic incineration can result in the production of harmful gases.

The presence of plastics in oceans creates additional problems as it can complicate navigation, entangle and kill marine life, harbor communities of pathogenic bacteria, and leach harmful chemicals into the environment. The presence of microplastics, very small plastic particles that are nearly ubiquitous in water supplies worldwide, is especially problematic as it makes plastic compounds more bioavailable to animals and humans.

Growing consumer environmental awareness, along with industry's desire for cost efficiency, demonstrates a need for plastic materials to have a desirable cradle-to-cradle product life cycle. For example, there is a need for plastic materials made from renewable sources (“bioplastics”) can easily degrade without leaching harmful materials. Currently available bioplastics are not without their drawback. For example, producing biodegradable plastics from shelled corn is not economically efficient, as it requires multi-step processes and competes for human food chain sources.

Lignin is non-human food biomass that is readily available as a byproduct of the biofuel and paper industry. The abundance of aromaticity in lignin is unique compared to other bioplastics, which are composed primarily of aliphatic structures. Lignin can be an excellent renewable resource for producing functional polymers instead of petroleum. In addition, lignin is biodegradable, and lignin-based polymers can be designed to be completely biodegradable. However, the preparation of various polymers from lignin can be complex, involve harsh chemistries, and is not economically valuable.

Environmental concerns are further exacerbated by global warming, which is at least partially caused by the greenhouse effect. CO₂ is a major contributor to the greenhouse effect, and as a result, many attempts are made to reduce CO₂ emissions and increase CO₂ utilization. CO₂ is a cheap and readily available carbon source that can be utilized in many chemical processes, such as synthesizing various polymers.

There remains a need for improved bioplastics and methods for producing them. There remains a need for improved recyclable bioplastics. There remains a need for improved systems and processes for valorizing lignin.

### SUMMARY

The present disclosure is generally methods of making lignin based polymers. In some aspects, such polymers are biodegradable.

In some aspects, disclosed is a method comprising: reacting a lignin-based material having one or more OH groups with a coupling reagent having formula (I) to form a first lignin-based material comprising one or more moieties of formula (II)

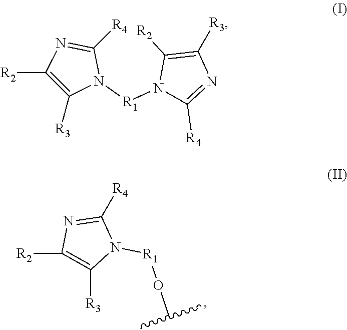

wherein R₁ is selected from —C(O)— or —C(S), and

wherein R₂, R₃, and R₄ are, each, and on each occasion, independent of the other, selected from: hydrogen, C₁-C₁₀ alkyl, C₁-C₁₀ alkoxy, C₆-C₁₄ aryl, C₁-C₁₃ heteroaryl, or C₆-C₁₄ aryloxy, wherein each of R₂, R₃, and R₄, each and on each occasion independent of the other, is optionally substituted with C₁-C₁₀ alkyl, C₁-C₁₀ alkoxy, C₂-C₁₀ alkenyl, C₂-C₁₀ alkynyl, C₆-C₁₄ aryl, C₁-C₁₃ heteroaryl, amino, carbonyl, ester, ether, halide, carboxyl, hydroxy, nitro, cyano, silyl, sulfo-oxo, sulfonyl, sulfone, sulfoxide, thiol, or phosphonyl.

In still further aspects, the methods further comprise reacting the first lignin-based material comprising one or more moieties of formula (II) with a first compound comprising at least one of OH group, COOH group, NH₂ group, or a combination thereof. In still further aspects, the step of reacting results in forming a second compound comprising one or more of a polycarbonate, polyester or polyurethane, such that the first compound is covalently bound to the first lignin-based material comprising one or more moieties of formula (II).

In still further aspects, the second compound is substantially biodegradable. Still further, also disclosed herein, is an article comprising the second compound formed by any of the disclosed herein methods.

In still further aspects, disclosed herein are polycarbonates formed by the disclosed methods. In still further aspects, disclosed herein are polyurethanes formed by the disclosed methods. In still further aspects, disclosed herein are polyesters formed by the disclosed methods.

Also disclosed is a method of making any of the disclosed herein articles. The method comprises steps of extrusion, compression molding, injection molding, transfer molding, blow molding, or any combination thereof.

Additional aspects of the invention will be set forth, in part, in the detailed description, figures, and claims which follow, and in part will be derived from the detailed description or can be learned by practice of the invention. It is to be understood that both the foregoing general description and the following detailed description are exemplary and explanatory only and are not restrictive of the invention as disclosed.

### DESCRIPTION OF DRAWINGS

FIG. 1A depicts representative structural fragments of lignin.

FIG. 1B depicts various structural moieties found within lignin.

### DETAILED DESCRIPTION

The present invention can be understood more readily by referencing the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

In this specification and in the claims that follow, reference will be made to a number of terms, which shall be defined to have the following meanings:

Throughout the description and claims of this specification, the word “comprise” and other forms of the word, such as “comprising” and “comprises,” means including but not limited to, and are not intended to exclude, for example, other additives, segments, integers, or steps. Furthermore, it is to be understood that the terms comprise, comprising, and comprises as they relate to various aspects, elements, and features of the disclosed invention also include the more limited aspects of “consisting essentially of” and “consisting of.”

As used herein, the singular forms “a,” “an,” and “the” include plural referents unless the context clearly dictates otherwise. Thus, for example, reference to a “polymer” includes aspects having two or more such polymers unless the context clearly indicates otherwise.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

For the terms “for example” and “such as,” and grammatical equivalences thereof, the phrase “and without limitation” is understood to follow unless explicitly stated otherwise.

As used herein, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, segment, composition, or other condition for which substantially is used to characterize or otherwise quantify an amount.

In other aspects, as used herein, the term “substantially free,” when used in the context of a composition or segment of a composition that is substantially absent, is intended to refer to an amount that is less than about 1% by weight, e.g., less than about 0.5% by weight, less than about 0.1% by weight, less than about 0.05% by weight, or less than about 0.01% by weight of the stated material, based on the total weight of the composition.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

A weight percent of a segment, unless specifically stated to the contrary, is based on the total weight of the formulation or composition in which the segment is included.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art using only routine experimentation.

As used herein, the term “biodegradable” refers to a material capable of being decomposed by bacteria or other living microorganisms.

As used herein, “Kraft lignin” refers to a lignin product of the sulfate pulping process. It is understood that Kraft lignin can comprise about 2-3 wt % of sulfur based on the total weight of the Kraft lignin.

As used herein, the terms “modified” and “functionalized” can be used interchangeably.

As used herein, the term “substituted” means that a hydrogen atom is removed and replaced by a substituent. It is contemplated to include all permissible substituents of organic compounds. As used herein, the phrase “optionally substituted” means unsubstituted or substituted. It is to be understood that substitution at a given atom is limited by valency. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein, which satisfy the valencies of the heteroatoms. This disclosure is not intended to be limited in any manner by the permissible substituents of organic compounds. Also, the terms “substitution” or “substituted with” include the implicit proviso that such substitution is in accordance with the permitted valence of the substituted atom and the substituent and that the substitution results in a stable compound, e.g., a compound that does not spontaneously undergo transformation such as by rearrangement, cyclization, elimination, etc. In still further aspects, it is understood that when the disclosure describes a group being substituted, it means that the group is substituted with one or more (i.e., 1, 2, 3, 4, or 5) groups as allowed by valence selected from alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “compound,” as used herein, is meant to include all stereoisomers, geometric isomers, tautomers, and isotopes of the structures depicted. Compounds herein identified by name or structure as one particular tautomeric form are intended to include other tautomeric forms unless otherwise specified.

Compounds provided herein also can include tautomeric forms. Tautomeric forms result from the swapping of a single bond with an adjacent double bond together with the concomitant migration of a proton. Tautomeric forms include prototropic tautomers that are isomeric protonation states having the same empirical formula and total charge. Example prototropic tautomers include ketone—enol pairs, amide—imidic add pairs, lactam lactim pairs, enamine imine pairs, and annular forms where a proton can occupy two or more positions of a heterocyclic system, for example, 1H- and 3H-imidazole, 1H-, 2H- and 4H-1,2,4-triazole, 1H- and 2H-isoindole, and 1H- and 2H-pyrazole. Tautomeric forms can be in equilibrium or sterically locked into one form by appropriate substitution.

Compounds provided herein can also include all isotopes of atoms occurring in the intermediates or final compounds. Isotopes include those atoms having the same atomic number but different mass numbers. For example, isotopes of hydrogen include hydrogen, tritium, and deuterium.

Also provided herein are salts of the compounds described herein. It is understood that the disclosed salts can refer to derivatives of the disclosed compounds wherein the parent compound is modified by converting an existing add or base moiety to its salt form. Examples of the salts include, but are not limited to, mineral or organic add salts of basic residues such as amines; alkali or organic salts of acidic residues such as carboxylic adds; and the like. The salts of the compounds provided herein include the conventional non-toxic salts of the parent compound formed, for example, from non-toxic inorganic or organic acids. The salts of the compounds provided herein can be synthesized from the parent compound that contains a basic or acidic moiety by conventional chemical methods. Generally, such salts can be prepared by reacting the free acid or base forms of these compounds with a stoichiometric amount of the appropriate base or acid in water or an organic solvent or in a mixture of the two. In various aspects, nonaqueous media like ether, ethyl acetate, alcohols (e.g., methanol, ethanol, isopropanol, or butanol) or acetonitrile (ACN) can be used.

In various aspects, the compounds provided herein, or salts thereof, are substantially isolated. By “substantially isolated,” it meant that the compound is at least partially or substantially separated from the environment in which it was formed or detected. Partial separation can include, for example, a composition enriched in the compounds provided herein. Substantial separation can include compositions containing at least about 50%, at least about 60%, at least about 70%, at least about 80%, at least about 90%, at least about 95%, at least about 97%, or at least about 99% by weight of the compounds provided herein, or salt thereof. Methods for isolating compounds and their salts are routine in the art.

As used herein, chemical structures that contain one or more stereocenters depicted with dashed and bold bonds are meant to indicate the absolute stereochemistry of the stereocenter(s) present in the chemical structure. As used herein, bonds symbolized by a simple line do not indicate a stereo-preference. Unless otherwise indicated to the contrary, chemical structures, which include one or more stereocenters, illustrated herein without indicating absolute or relative stereochemistry encompass all possible stereoisomeric forms of the compound (e.g., diastereomers and enantiomers) and mixtures thereof. Structures with a single bold or dashed line and at least one additional simple line encompass a single enantiomeric series of all possible diastereomers.

The expressions “ambient temperature” and “room temperature” as used herein are understood in the art and refer generally to a temperature, e.g., a reaction temperature, which is about the temperature of the room in which the reaction is conducted, for example, a temperature from about 20° C. to about 30° C.

“R¹,” “R²,” “R³,” “R⁴,” etc., are used herein as generic symbols to represent various specific substituents. These symbols can be any substituents, not limited to those disclosed herein, and when they are defined to be certain substituents in one instance, they can, in another instance, be defined as some other substituents.

As used herein, the term “amine base” refers to a mono-substituted amino group (i.e., primary amine base), di-substituted amino group (i.e., secondary amine base), or a tri-substituted amine group (i.e., tertiary amine base). Exemplary mono-substituted amine bases include methylamine, ethylamine, propylamine, butylamine, and the like. Examples of di-substituted amine bases include dimethylamine, diethylamine, dipropylamine, dibutylamine, pyrrolidine, piperidine, azepane, morpholine, and the like. In various aspects, the tertiary amine has the formula N(R′)₃, wherein each R′ is independently C₁-C₆ alkyl, 3-10 member cycloalkyl, 4-10 membered heterocycloalkyl, 1-10 membered heteroaryl, and 5-10 membered aryl, wherein the 3-10 member cycloalkyl, 4-10 membered heterocycloalkyl, 1-10 membered heteroaryl, and 5-10 membered aryl is optionally substituted by 1, 2, 3, 4, 5, or 6 Ci-6 alkyl groups. Exemplary tertiary amine bases include trimethylamine, diethylamine, tripropylamine, triisopropylamine, tributylamine, tri-tert-butylamine, N,N-dimethylethanamine, N-ethyl-N-methylpropan-2-amine, N-ethyl-N-isopropylpropan-2-amine, morpholine, N-methylmorpholine, and the like. In various aspects, the term “tertiary amine base” refers to a group of formula N(R)₃, wherein each R is independently a linear or branched C₁₋₆ alkyl group.

“Leaving group,” as used herein, refers to a molecule or a molecular fragment (e.g., an anion) that is displaced in a chemical reaction as stable species taking with it the bonding electrons. Examples of leaving groups include an arylsulfonyloxy group or an alkylsulfonyloxy group, such as a mesylate or a tosylate group. Common anionic leaving groups also include halides such as Cl—, Br—, and I—.

As used herein, substantially pure means sufficiently homogeneous to appear free of readily detectable impurities as determined by standard methods of analysis, such as thin-layer chromatography (TLC), nuclear magnetic resonance (NMR), gel electrophoresis, high-performance liquid chromatography (HPLC) and mass spectrometry (MS), gas-chromatography mass spectrometry (GC-MS), and similar, used by those of skill in the art to assess such purity, or sufficiently pure such that further purification would not detectably alter the physical and chemical properties, such as enzymatic and biological activities, of the substance. Both traditional and modern methods for purification of the compounds to produce substantially chemically pure compounds are known to those of skill in the art. A substantially chemically pure compound can, however, be a mixture of stereoisomers.

Preparation of the compounds described herein can involve a reaction in the presence of an acid or a base. Example adds can be inorganic or organic adds and include, but are not limited to, strong and weak acids. Example acids include, but are not limited to, hydrochloric acid, hydrobromic acid, sulfuric acid, phosphoric acid, p-toluenesulfonic add, 4-nitrobenzoic acid, methanesulfonic add, benzenesuifonic acid, trifluoroacetic acid, and nitric acid. Example weak acids include, but are not limited to, acetic add, propionic add, butanoic add, benzoic add, tartaric acid, pentanoic acid, hexanoic acid, heptanoic add, octanoic add, nonanoic acid, and decanoic acid. Examples include, without limitation, lithium hydroxide, sodium hydroxide, potassium hydroxide, lithium carbonate, sodium carbonate, potassium carbonate, sodium bicarbonate, and amine bases. Example strong bases include, but are not limited to, hydroxide, alkoxides, metal amides, metal hydrides, metal dialkylamides, and arylamines, wherein; alkoxides include lithium, sodium and potassium salts of methyl, ethyl and t-butyl oxides; metal amides include sodium amide, potassium amide, and lithium amide; metal hydrides include sodium hydride, potassium hydride, and lithium hydride; and metal diaikylamides include lithium, sodium, and potassium salts of methyl, ethyl, n-propyl, isopropyl, n-butyl, t-butyl, trimethyisilyl, and cyclohexyl substituted amides (e.g., lithium N-isopropylcyclohexylamide).

The following abbreviations may be used herein: AcOH (acetic acid); aq. (aqueous); atm. (atmosphere(s)); Br₂ (bromine); Bn (benzyl); calc. (calculated); d (doublet); dd (doublet of doublets); DOM (dichloromethane); DMF (N,N-dirnethylformamide); Et (ethyl); Et₂O (diethyl ether); EtOAc (ethyl acetate); EtOH (ethanol); EWG (electron withdrawing group); g (gram(s)); h (hour(s)); HCl (hydrochloric acid/hydrogen chloride); HPLC (high performance liquid chromatography); H₂SO₄ (sulfuric acid); Hz (hertz); (iodine); IPA (isopropyl alcohol); J (coupling constant); KOH (potassium hydroxide); K₃PO₄ (potassium phosphate); LCMS (liquid chromatography—mass spectrometry); GC (gas chromatography), LilCA (lithium N-isopropylcyclohexylamide); m (multiplet); M (molar); MS (Mass spectrometry); Me (methyl); MeCN (acetonitrile); MeOH (methanol); mg (milligram(s)); min. (minutes(s)); mL (milliliter(s)); mmol (millimole(s)); N (normal); NaBH₄CN (sodium cyanoborohydride); NHP (N-heterocyclic phosphine); NHP—C1 (N-heterocyclic phosphine chloride); Na₂SO₃ (sodium carbonate); NaHCO₃(sodium bicarbonate); NaOH (sodium hydroxide); Na₂SO₄ (sodium sulfate); nM (nanomolar); NMR (nuclear magnetic resonance spectroscopy); PCb (trichlorophosphine); PMP (4-methoxyphenyl); RP-HPLC (reverse phase high performance liquid chromatography); t (triplet or tertiary); t-Bu (teri-butyl); TEA (triethylamine); TFA (trifluoroacetic acid); THF (tetrahydrofuran); TLC (thin layer chromatography); μg (microgram(s)); μL (microliter(s)); μM (micromolar); wt (weight percent).

Reference will now be made in detail to specific aspects of the disclosed materials, compounds, compositions, articles, and methods, examples of which are illustrated in the accompanying Examples.

### METHODS AND COMPOSITIONS

Disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutations of these compounds may not be explicitly disclosed, each is specifically contemplated and described herein. For example, suppose a composition is disclosed, and a number of modifications that can be made to a number of components of the composition are discussed. In that case, each and every combination and permutation that are possible are specifically contemplated unless specifically indicated to the contrary. Thus, if a class of components A, B, and C are disclosed and a class of components D, E, and F and an example of a combination composition A-D is disclosed, then even if each is not individually recited, each is individually and collectively contemplated. Thus, in this example, each of the combinations A-E, A-F, B-D, μ-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure, including, but not limited to, steps in methods of making and using the disclosed compositions. Thus, if there are a variety of additional steps that can be performed, it is understood that each of these additional steps can be performed with any specific aspect or combination of aspects of the disclosed methods and that each such combination is specifically contemplated and should be considered disclosed.

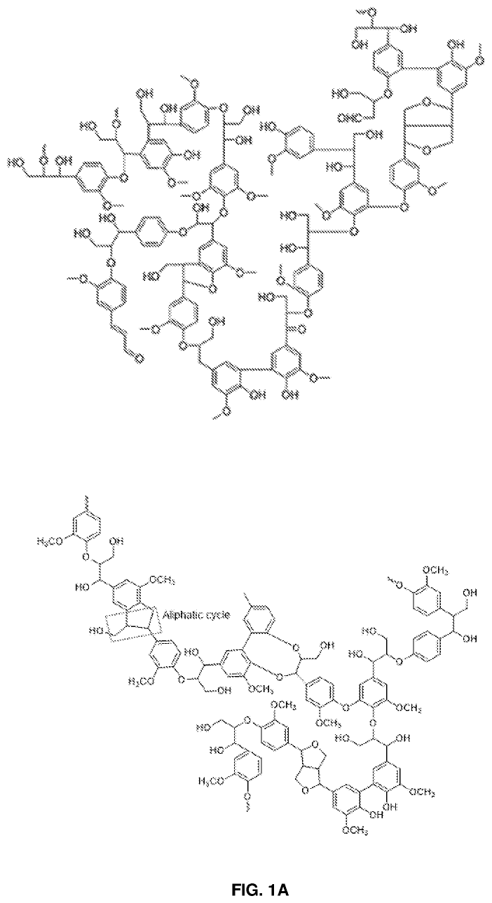

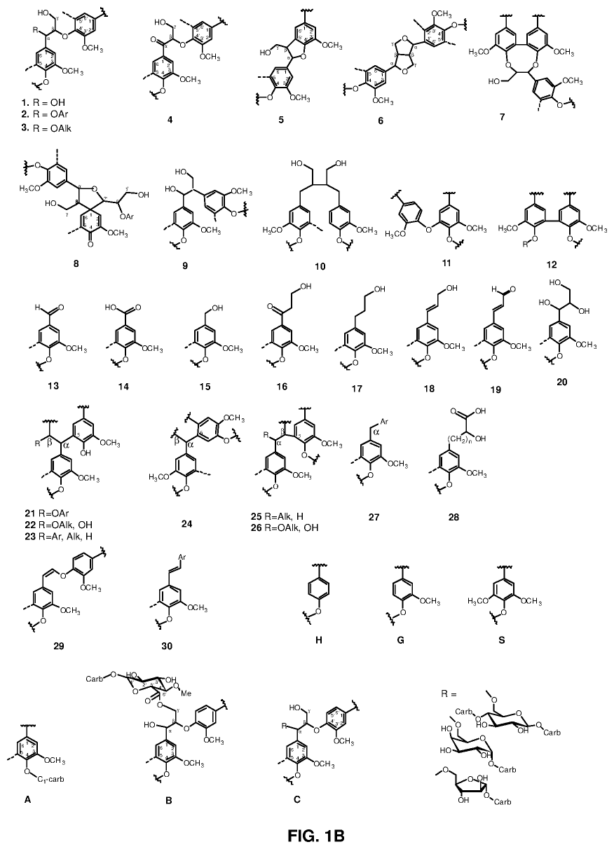

Native lignin is the second most abundant natural polymer on Earth. It is an irregular heterogeneous polymer. FIG. 1A shows an exemplary (partial) lignin structure, depicting various functional groups that can occur within a given lignin sample. The repeatable (monomeric) unit in lignin is the phenylpropane unit (or the so-called C9-unit) of the p-hydroxyphenyl (H), guaiacyl (G) and syringyl (S) types (FIG. 1B). Coniferous lignins are predominantly of the G-type. Hardwood lignins contain both G-units and S-units. The H-unit content in woody lignin is usually low; however, the H-unit content can significantly contribute to the structure of non-woody lignins (for instance, lignins derived from annual fibers). In addition, annual fiber lignins contain significant amounts of cinnamic and ferulic acid derivatives attached to the lignin predominantly by ester linkages with the gamma hydroxyl of the C9-units.

Lignin C9-units can contain different functional groups. The most common functional groups are aromatic methoxyl and phenolic hydroxyl, primary and secondary aliphatic hydroxyls, small amounts of carbonyl groups (of the aldehyde and ketone types) and carboxyl groups. The monomeric C₉ lignin units are linked together to form the polymeric structure of lignin via C—O—C and C—C linkages. The most abundant lignin inter-unit linkage is the β-O-4 type of linkage (see structures 1-4 and 7 of FIG. 1B). They constitute about 50% of the inter-unit linkages in lignin (about 45% in softwoods, and up to 60-65% in hardwoods). Other common lignin inter-unit linkages are the resinol (β-β) (structure 6), phenylcoumaran (β-5) (structure 5), 5-5 (structure 12) and 4-O-5 (structure 11) moieties. Their number varies in different lignins but typically does not exceed 10% of the total lignin moieties. The number of other lignin moieties is usually below 5%.

The degree of lignin condensation (“DC”) is an important lignin characteristic, as it is often negatively correlated with lignin reactivity. Most commonly, condensed lignin structures are lignin moieties linked to other lignin units via the 2, 5 or 6 positions of the aromatic ring (in H-units also via the C-3 position). The most common condensed structures are 5-5′, β-5 and 4-O-5′ structures. Since the C-5 position of the syringyl aromatic ring is occupied by a methoxyl group, and therefore it cannot be involved in condensation, hardwood lignins are typically less condensed than softwood lignins.

Technical lignins are obtained as a result of lignocellulosic biomass processing. Technical lignins are more heterogeneous (in terms of chemical structure and molecular mass) than native lignins. Technical lignins can have a higher amount of phenolic hydroxyls than native lignin and have a smaller molecular weight. Technical lignins can have a smaller amount of aliphatic hydroxyls, oxygenated aliphatic moieties and the formation of carboxyl groups and saturated aliphatic structures. The actual structure of technical lignins also depends on the specific biomass processing (acidic vs. basic, and the like).

Lignins suitable for the disclosed processes include those having the following structures:

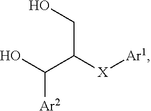

wherein X is a bond or O, and Ar′ and Ar 2 are independently an aromatic ring in a lignin structural moiety, for example as depicted in FIG. 1b such as any of moieties 1-30. In some implementations the lignin is one of moieties 2, 3, 4, 9, 10, 15, 16, 17, 18, or 20. When Ar¹ and Ar 2 are lignin structural moieties as shown in FIG. 1b, the dashed line indicates a point of attachment to the fragment above. The skilled person understands that other undefined substituents may be selected from H, CH₃, or another lignin structural moiety. By way of example, one such fragment that has been observed has the formula:

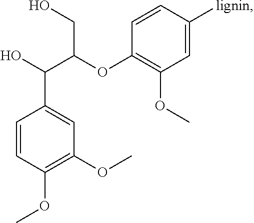

wherein “lignin” represents one or more additional phenyl propane unit as described above. Unless specifically stated to the contrary, the use of an exemplary lignin fragment such as shown above is not intended to limit the disclosed processes, monomers, and polymers to the specifically depicted substitution pattern.

The large abundance of lignin makes it a unique material to be used as a source of other biodegradable polymers. It is understood that the present disclosure is not limited to any specific types of lignin. In certain aspects, the lignin used in the current disclosure can be obtained from natural lignin products or synthetic model lignin compounds. In still further aspects, lignin used in the current disclosure can be obtained from natural lignin products. It is understood that the natural lignin product can comprise softwood lignin, hardwood lignin, or a combination thereof. In certain aspects and without limitations, the natural lignin product can be obtained from agricultural residues (including corn stover and sugarcane bagasse), (2) dedicated energy crops, (3) wood residues (including sawmill and paper mill discards), and (4) municipal waste, and their constituent parts. In still further aspects, the natural lignin product can be obtained from the paper industry. In certain aspects, lignin used herein can comprise Kraft lignin and lignosulfonate. In certain implementations, the lignin can have a weight average molecular weight (M_{w}) from 10,000-25,000 g/mol, 25,000-50,000 g/mol, 10,000-50,000 g/mol, 1,000-10,000 g/mol, from 1,000-5,000 g/mol, from 1,000-2,000 g/mol, from 1,000-3,000 g/mol, from 1,000-4,000 g/mol, from 2,000-5,000 g/mol, from 2,000-4,000 g/mol, from 2,000-3,000 g/mol, from 3,000-5,000 g/mol, or from 4,000-5,000 g/mol. In certain implementations, the lignin can have a number average molecular weight (Mₙ) from 500-2,000 g/mol, from 500-1,000 g/mol, from 500-750 g/mol, from 750-1,000 g/mol, from 1,000-1,250 g/mol, from 1,000-1,500 g/mol, from 1,250-1,750 g/mol, from 1,250-1,500 g/mol, from 1,500-2,000 g/mol, from 1,500-1,750 g/mol, or from 1,750-2,000 g/mol. In certain implementations, the lignin can have polydispersity index (PDI Mw/Mn) from 1-5, from 2-5, from 3-5, from 4-5, from 1-1.5, from 1.5-2 from 1-2, from 1-3, from 1-4, from 2-5, from 2-4, from 2-3, from 2-2.5, from 2.5-3, from 3-5, from 3-4, from 3-3.5, from 3.5-4, from 4-4.5, from 4.5-5, or from 4-5. In certain implementations, the molecular weights can be determined using HPLC, in some implementations the molecular weights can be determined using GPC.

Disclosed herein are methods of forming various biodegradable polycarbonates, polyurethanes and polyesters from lignin based materials. In certain aspects disclosed herein are methods comprising: reacting a lignin-based material having one or more OH groups with a coupling reagent having a formula (I) to form a first lignin-based material comprising one or more moieties of formula (II)

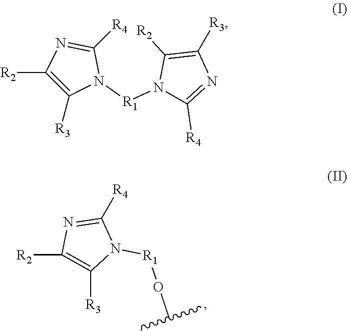

wherein R₁ is selected from —C(O)— or —C(S), and

wherein R₂, R₃, and R₄ are, each, and on each occasion, independent of the other, selected from: hydrogen, C₁-C₁₀ alkyl, C₁-C₁₀ alkoxy, C₆-C₁₄ aryl, C₁-C₁₃ heteroaryl, or C₆-C₁₄ aryloxy, wherein each of R₂, R₃, and R₄, each and on each occasion independent of the other, is optionally substituted with C₁-C₁₀ alkyl, C₁-C₁₀ alkoxy, C₂-C₁₀ alkenyl, C₂-C₁₀ alkynyl, C₆-C₁₄ aryl, C₁-C₁₃ heteroaryl, amino, carbonyl, ester, ether, halide, carboxyl, hydroxy, nitro, cyano, silyl, sulfo-oxo, sulfonyl, sulfone, sulfoxide, thiol, or phosphonyl. In certain implementations, each of R₂, R₃, and R₄ are hydrogen.

In certain aspects, the lignin-based material can be schematically shown as formula (III):

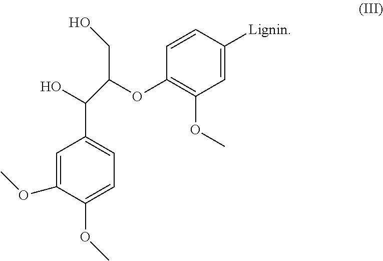

In still further aspects, the lignin-based material can have a weight-average molecular weight from about 2,000 to about 200,000 Dalton, including exemplary values of about 5,000 Dalton, about 10,000 Dalton, about 20,000 Dalton, about 50,000 Dalton, about 70,000 Dalton, about 100,000 Dalton, about 105,000 Dalton, about 110,000 Dalton, about 120,000 Dalton, about 150,000 Dalton, about 170,000 Dalton, and about 190,000 Dalton.

In still further aspects, the coupling reagent of formula (I) can be carbonyldiimidazole (i.e., di(1H-imidazol-1-yl)methanone), or an analog thereof.

In yet other aspects, in some aspects, the coupling reagent of formula (I) can be di(1H-imidazol-1-yl)methanethione

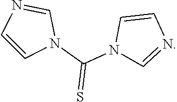 [SMILES: S=C(n1ccnc1)n1ccnc1]

In the methods disclosed herein, the step of reacting is performed at a temperature from about 20° C. to about 35° C., including exemplary values of about 21° C., about 22° C., about 23° C., about 24° C., about 25° C., about 26° C., about 27° C., about 28° C., about 29° C., about 30° C., about 31° C., about 32° C., about 33° C., and about 34° C. In yet still further aspects, the step of reacting is performed at room temperature. In certain implementations, the reaction is conducted at a temperature from 10-100° C., from 10-50° C., from 10-25° C., from 25-50° C., from 20-35° C., from 30-50° C. from 40-60° C., or from 50-100° C.

In some implementations, the coupling reagent can be present in an amount (relative to the amount of the lignin) that is from 0.01-10 wt. %, from 0.01-1 wt. %, from 0.01-0.1 wt. %, from 0.1-0.25 wt. %, from 0.1-0.5 wt. %, form 0.25-0.5 wt. %, from 0.1-1 wt. %, from 0.5-1 wt. %, from 1-2.5 wt. %, from 1-5 wt. %, or from 2.5-5 wt. %.

In still further aspects, the first lignin-based material comprising one or more moieties of formula (II) is formed:

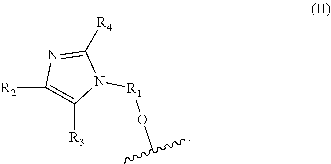

It is understood that the dashed line here shows all other potential configurations of the lignin molecule. In yet still further aspects, the R₁ is selected from —C(O)— or —C(S), depending on the specific coupling reagent used in the reaction. In yet still further aspects, R₂, R₃, and R₄ can be the same as in the coupling reagent and can be each, and on each occasion, independent of the other, selected from: hydrogen, C₁-C₁₀ alkyl, C₁-C₁₀ alkoxy, C₆-C₁₄ aryl, C₁-C₁₃ heteroaryl, or C₆-C₁₄ aryloxy, wherein each of R₂, R₃, and R₄, independent of the other, is optionally substituted with C₁-C₁₀ alkyl, C₁-C₁₀ alkoxy, C₂-C₁₀ alkenyl, C₂-C₁₀ alkynyl, C₆-C₁₄ aryl, C₁-C₁₃ heteroaryl, amino, carbonyl, ester, ether, halide, carboxyl, hydroxy, nitro, cyano, silyl, sulfo-oxo, sulfonyl, sulfone, sulfoxide, thiol, or phosphonyl.

In certain aspects, the step of reacting between the lignin-based material and coupling reagent can be presented as shown in Reaction 1:

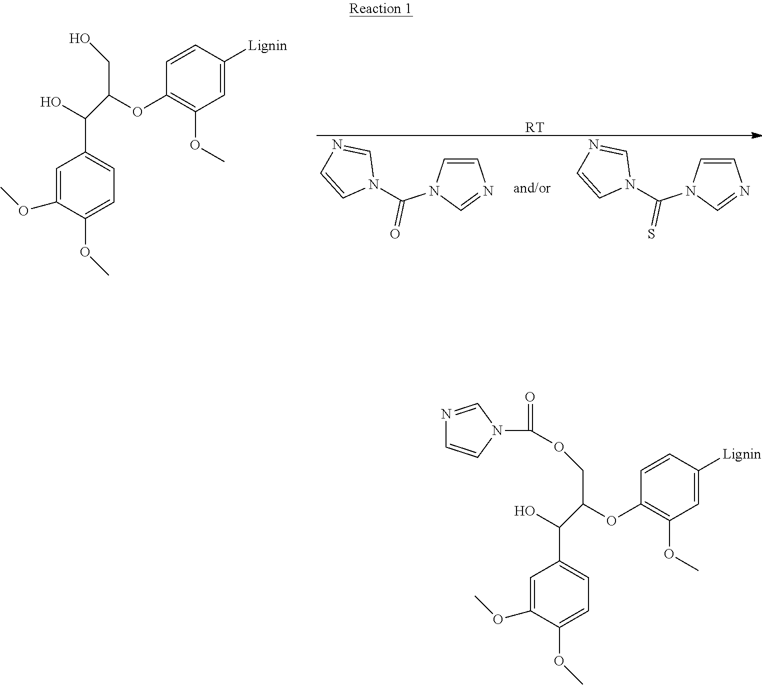

In still further aspects, the methods disclosed herein further comprise reacting the first lignin-based material comprising one or more moieties of formula (II) with a first compound comprising at least one of OH group, COOH group, NH₂ group, or a combination thereof. For example, when R₁ is C(O) and R₂, R₃, and R₄ are all hydrogen, the reaction between the first lignin-based material comprising one or more moieties of formula (II) with a first compound comprising at least one of the OH group, COOH group, NH₂ group, or a combination thereof can be shown schematically in Reaction 2:

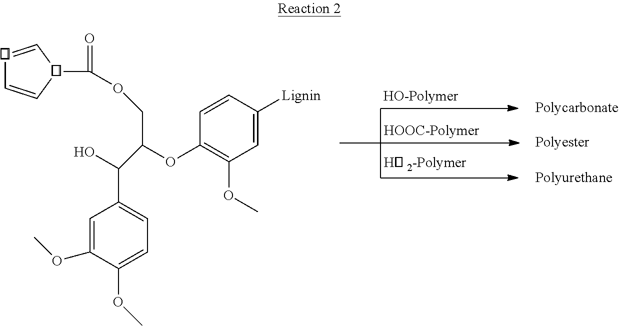

In still further aspects, the step of reacting results in forming a second compound comprising one or more of a polycarbonate, polyester or polyurethane, such that the first compound is covalently bound to the first lignin-based material comprising one or more moieties of formula (II).

In still further aspects, the first compound can comprise a functional chemical compound, a biological compound, or a combination thereof. In yet other aspects, the first compound is an oligomer or a polymer. In yet still further aspects, the first compound comprises poly(lactic acid) and analogs thereof, polysaccharides, polyglycol, polyvinyl alcohol, hydroxyl group-containing methacrylate/acrylate (e.g., (Hydroxyethyl)methacrylate, Glycerol mono-methacrylate, 4-hydroxybutyl acrylate) and acrylamide (e.g., N-Hydroxyethyl acrylamide, N-(2-Hydroxypropyl)methacrylamide), poly allyl alcohols, or any combinations thereof.

In certain implementations, the first compound comprises a polysaccharide, polypeptide, polyester, polycarbonate, polyamide, polyurethane, polyalkylene glycol, or a combination thereof.

In certain implementations, the first compound comprises poly(lactic acid), bisphenol, polyglycolic acid, poly(lactide-co-glycolic acid), polybutyrate, polybutylene succinate, polyethylene terephthalate, nylon, polypropylene terephthalate, polyvinyl alcohol, polyethylene glycol, (hydroxyethyl)methacrylate, glycerol mono-methacrylate, 4-hydroxybutyl acrylate), N-hydroxyethyl acrylamide, N-(2-hydroxypropyl)methacrylamide), poly allyl alcohols, or any combinations thereof.

In certain implementations, the first compound comprises cellulose, starch, chitosan, chitin, pectin, xanthan gum, dextran, gellan gum, hyaluronic acid, or a combination thereof.

In yet still further aspects, the second compound can be substantially biodegradable. While in yet further aspects, the second compound can be fully biodegradable.

In still further aspects, the second compound can be a lignin-based polycarbonate. In yet still further aspects, disclosed herein is a polycarbonate formed by any of the disclosed herein methods. In such aspects, the lignin-based material can form —OCOO— covalent linkages with the first compound and form covalently bound lignin based polycarbonate.

In still further aspects, the second compound can be a lignin-based polyurethane. In yet still further aspects, disclosed herein is a polyurethane formed by any of the disclosed herein methods. In such aspects, the lignin-based material can form —NH₂COO— covalent linkages with the first compound and form covalently bound lignin based polyurethane. In still further aspects, the resulting lignin-based polyurethane can have elastomeric properties.

In still further aspects, the second compound can be a lignin-based polyester. In yet still further aspects, disclosed herein is a polyester formed by any of the disclosed herein methods. In such aspects, the lignin-based material can form —COO— covalent linkages with the first compound and form covalently bound lignin based polyester.

In yet still further aspects, any of the disclosed herein second compounds can have any desired molecular weight. For example, the molecular weight of the second compound can range from about 1,000 Da to about 200,000 Da, including exemplary values of about 5,000 Da, about 10,000 Da, about 15,000 Da, about 20,000 Da, about 25,000 Da, about 30,000 Da, about 35,000 Da, about 40,000 Da, about 45,000 Da, about 50,000 Da, about 55,000 Da, about 60,000 Da, about 65,000 Da, about 70,000 Da, about 75,000 Da, about 80,000 Da, about 85,000 Da, about 90,000 Da, about 95,000 Da, about 100,000 Da about 105,000 Da, about 110,000 Da, about 115,000 Da, about 120,000 Da, about 125,000 Da, about 130,000 Da, about 135,000 Da, about 140,000 Da, about 145,000 Da, about 150,000 Da, about 155,000 Da, about 160,000 Da, about 165,000 Da, about 170,000 Da, about 175,000 Da, about 180,000 Da, about 185,000 Da, about 190,000 Da, and about 195,000 Da.

Also disclosed herein are articles comprising the second compound produced by the disclosed herein method. For example, disclosed herein is an article comprising lignin-based polycarbonate. In yet other aspects, disclosed herein is an article comprising lignin-based polyurethane. In yet still, further aspects, disclosed herein is an article comprising lignin-based polyester. In still further aspects, the articles formed herein can be used in the field of medicine, bioengineering electronics, textile, containers, furniture, automotive, military equipment, coatings, appliances, films, and the like. In certain aspects, the articles prepared from the disclosed biodegradable lignin-based polymers can also comprise packaging, food packaging, disposable cutlery, tableware, film, bags, nets, or any combination thereof.

In still further aspects, disclosed are methods of making the articles, wherein the methods can comprise a step of extrusion, compression molding, injection molding, transfer molding, blow molding, or any combination thereof.

What is claimed is:

1. A method comprising:
reacting a lignin-based material having one or more OH groups with a coupling reagent having a formula (I) to form a first lignin-based material comprising one or more moieties of formula (II) 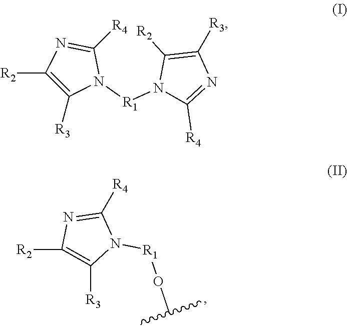
wherein R₁ is selected from —C(O)— or —C(S), and
wherein R₂, R₃, and R₄ are, each, and on each occasion, independent of the other, selected from: hydrogen, C₁-C₁₀ alkyl, C₁-C₁₀ alkoxy, C₆-C₁₄ aryl, C₁-C₁₃ heteroaryl, or C₆-C₁₄ aryloxy, wherein each of R₂, R₃, and R₄, each and on each occasion independent of the other, is optionally substituted with C₁-C₁₀ alkyl, C₁-C₁₀ alkoxy, C₂-C₁₀ alkenyl, C₂-C₁₀ alkynyl, C₆-C₁₄ aryl, C₁-C₁₃ heteroaryl, amino, carbonyl, ester, ether, halide, carboxyl, hydroxy, nitro, cyano, silyl, sulfo-oxo, sulfonyl, sulfone, sulfoxide, thiol, or phosphonyl.

2. The method of claim 1, wherein the coupling reagent (II) is:

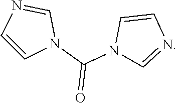 [SMILES: O=C(n1ccnc1)n1ccnc1]

3. The method of claim 1, wherein the coupling reagent (II) is:

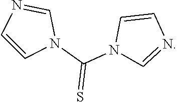 [SMILES: S=C(n1ccnc1)n1ccnc1]

4. The method of claim 1, wherein the step of reacting is performed at a temperature from about 20° C. to about 35° C.

5. The method of claim 1, wherein the lignin has a weight average molecular weight (M_{w}) from 10,000-25,000 g/mol, 25,000-50,000 g/mol, 10,000-50,000 g/mol, 1,000-10,000 g/mol, from 1,000-5,000 g/mol, from 1,000-2,000 g/mol, from 1,000-3,000 g/mol, from 1,000-4,000 g/mol, from 2,000-5,000 g/mol, from 2,000-4,000 g/mol, from 2,000-3,000 g/mol, from 3,000-5,000 g/mol, or from 4,000-5,000 g/mol.

6. The method of claim 1, further comprising reacting the first lignin-based material comprising one or more moieties of formula (II) with a first compound comprising at least one of OH group, COOH group, NH₂ group, or a combination thereof.

7. The method of claim 6, wherein the step of reacting results in forming a second compound comprising one or more of a polycarbonate, polyester or polyurethane, such that the first compound is covalently bound to the first lignin-based material comprising one or more moieties of formula (II).

8. The method of claim 6, wherein the first compound comprises a functional chemical compound, a biological compound, or a combination thereof.

9. The method of claim 6, wherein the first compound is an oligomer or a polymer.

10. The method of claim 6, wherein the first compound comprises a polysaccharide, polypeptide, polyester, polycarbonate, polyamide, polyurethane, polyalkylene glycol, or a combination thereof.

11. The method of claim 6, wherein the first compound comprises poly(lactic acid), bisphenol, polyglycolic acid, poly(lactide-co-glycolic acid), polybutyrate, polybutylene succinate, polyethylene terephthalate, nylon, polypropylene terephthalate, polyvinyl alcohol, polyethylene glycol, (hydroxyethyl)methacrylate, glycerol mono-methacrylate, 4-hydroxybutyl acrylate), N-hydroxyethyl acrylamide, N-(2-hydroxypropyl)methacrylamide), poly allyl alcohols, or any combinations thereof.

12. The method of claim 6, wherein the first compound comprises cellulose, starch, chitosan, chitin, pectin, xanthan gum, dextran, gellan gum, hyaluronic acid, or a combination thereof.

13. The method of claim 6, wherein the second compound is biodegradable.

14. A polycarbonate formed by the method of claim 1.

15. A polyurethane formed by the method of claim 1.

16. A polyester formed by the method of claim 1.
